(19) United States
(12) Patent Application Publication
(10) Pub. No.: US 2016/0348656 A1
(43) Pub. Date: Dec. 1, 2016

(54) SUPPORT SYSTEM FOR A PUMP

(71) Applicant: Caterpillar Inc., Peoria, IL (US)

(72) Inventors: Daniel Raymond BALDWIN, Peoria, IL (US); Alan Ray STOCKNER, Metamora, IL (US)

(73) Assignee: Caterpillar Inc., Peoria, IL (US)

(21) Appl. No.: 14/727,704

(22) Filed: Jun. 1, 2015

(51) Int. Cl. F04B 9/10; F02B 61/00; F04B 23/02; F04B 15/00; F04B 19/22

(52) U.S. Cl. CPC F04B 9/10; F04B 15/00; F04B 19/22; F04B 23/021; F02B 61/00

(57) ABSTRACT

A support system for a pump having a plurality of pumping elements is disclosed. The support system may include a first flange, a second flange opposite the first flange, and a support member between and abutting the first and second flanges. The support system may further include a plurality of fasteners, each being coaxially aligned with a respective one of the plurality of pumping elements, wherein each of the plurality of fasteners is configured to draw the actuating and pressurizing ends against the support member.

### TECHNICAL FIELD

The present disclosure relates generally to a support system and, more particularly, to a support system for a pump.

### BACKGROUND

Gaseous fuel powered engines are common in many applications. For example, the engine of a locomotive can be powered by natural gas (or another gaseous fuel) alone, or by a mixture of natural gas and diesel fuel. Natural gas may be more abundant and, therefore, less expensive than diesel fuel. In addition, natural gas may burn cleaner in some applications.

Natural gas, when used in a mobile application, may be stored in a liquid state within a tank onboard the associated machine. This may require the natural gas to be stored at cold temperatures, typically about −100 to −162° C. The liquefied natural gas (LNG) may then be drawn from the tank and directed to a high-pressure pump that further increases a pressure of the fuel and directs the fuel to the machine's engine. In some applications, the high pressure pump may be an in-tank pump that extends from a top portion of the tank's interior to a bottom portion, where fluid is drawn into an inlet of the pump.

One problem associated with in-tank pumps involves structurally connecting an upper portion of the pump near the top of the tank to a lower portion of the pump near the bottom of the tank. Forces generated during the pumping process can produce tensile stresses and cause deflection and stretching in components that connect the upper and lower portions of the pump, which can reduce the life and performance of the pump. Using additional or larger structural support members to resist stretching can increase the amount of material needed to construct the pump, thereby increasing the weight and thermal mass of the pump. Heavier pumps can be more difficult to install and service, and the additional weight can reduce the fuel efficiency of an associated mobile machine. Further, pumps with greater thermal mass can transfer more heat into the tank from the surroundings, which can cause liquid fuel within the tank to vaporize.

One attempt to support an in-tank pump in a cryogenic storage tank is disclosed in U.S. Pat. No. 4,860,545 (the '545 patent) that issued to Zwick et al. on Aug. 29, 1989. In particular, the '545 patent discloses a pump mounting tube that is bolted to the top of the tank via a flange. The pump mounting tube extends through an opening in the top of the tank toward the bottom end of the tank. As pump extension tube is bolted to the top of the tank via the flange and passes through the pump mounting tube to support a piston and valve unit at its lower end. At its upper end, the pump extension tube connects to a pump head located outside the tank. A drive shaft passes from the pump head to the piston and valve unit via the pump extension tube.

While the pump extension tube of the '545 patent may support the piston and valve unit near the bottom of the tank, it may not be optimum. For example, the extension tube may only resist deflection near the top of the tank where it is bolted to the flange. Further, the extension tube may transfer a significant amount of heat to the piston and valve unit.

The disclosed support system is directed to overcoming one or more of the problems set forth above and/or other problems of the prior art.

### SUMMARY

In one aspect, the present disclosure is directed to a support system for a pump having a plurality of pumping elements. The support system may include a first flange, a second flange opposite the first flange, and a support member between and abutting the first and second flanges. The support system may further include a plurality of fasteners, each being coaxially aligned with a respective one of the plurality of pumping elements, wherein each of the plurality of fasteners is configured to draw the actuating and pressurizing ends against the support member.

In another aspect, the present disclosure is directed to a pump. The pump may include an actuating end having a driving mechanism, and a pressurizing end opposite the actuating end. The pressurizing end may include a plurality of pumping elements. The pump may further include a plurality of actuators, each configured to be reciprocally driven between the driving mechanism and a respective one of the plurality of pumping elements. The pump may further include a support member between and abutting the actuating and pressurizing ends. The pump may further include a plurality of fasteners, each being configured to draw the actuating and pressurizing ends against the support member. Each of the plurality of actuators may be slidably disposed within a respective one of the plurality of fasteners.

In yet another aspect, the present disclosure is directed to a pump. The pump may include an actuating end having a driving mechanism, and a pressurizing end opposite the actuating end and including a plurality of pumping elements. Each of the plurality of pumping elements may be spaced radially outward from and symmetrically arranged about an axial center of the pump. The pump may further include a plurality of actuators, each configured to be reciprocally driven between the driving mechanism and a respective one of the plurality of pumping elements. The pump may further include a first flange connected to the actuating end, a second flange connected to the pressurizing end, a support member between and abutting the first and second flanges. The pump may further include a plurality of fasteners, each being connected to the first and second flanges and configured to draw the actuating and pressurizing ends against the support member. Each of the plurality of fasteners may include a guide bore passing through a center of the respective fastener. Each of the plurality of actuators may be slidably disposed within the guide bore of a respective one of the plurality of fasteners.

### BRIEF DESCRIPTION OF THE DRAWINGS

FIG. 1 is a cross sectional illustration of an exemplary disclosed tank and pump;

FIG. 2 is a vertical cross sectional illustration of the exemplary disclosed pump of FIG. 1; and

FIGS. 3 and 4 are horizontal cross sectional illustrations of the exemplary pump of FIG. 1.

### DETAILED DESCRIPTION

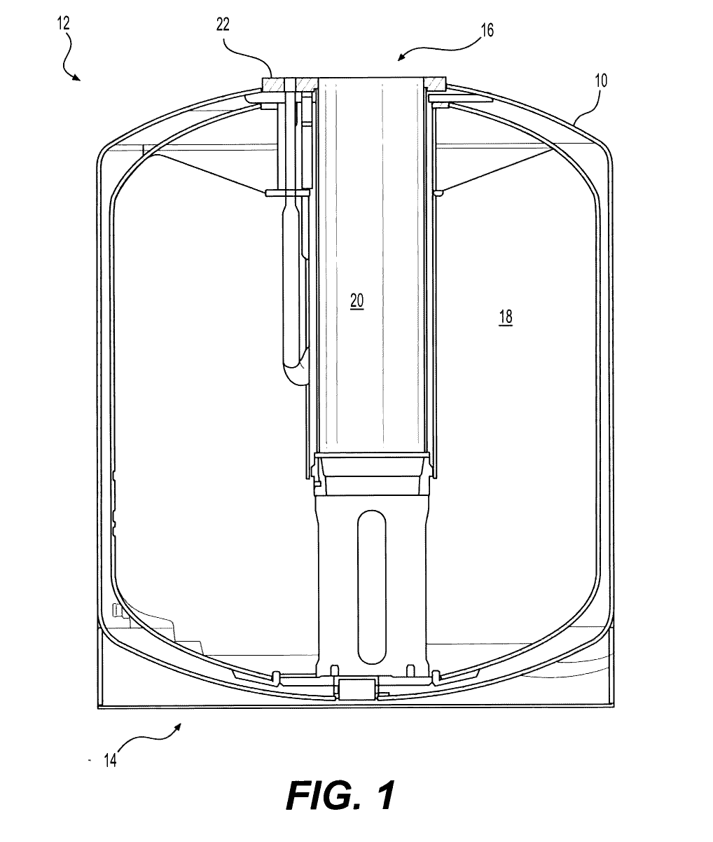

FIG. 1 illustrates a tank 10 that may be used to store a pressurized fuel, such as a cryogenic fluid (e.g., liquefied natural gas (LNG), helium, hydrogen, nitrogen, oxygen, etc.). Tank 10 may be used to store other gaseous fuels, if desired. Tank 10 may have a top end 12 and a bottom end 14 opposite top end 12. Top end 12 may have an opening 16 that leads to an interior cavity 18 of tank 10, where the pressurized fuel may be stored. A pump 20 may extend from the top end 12 of tank 10 into cavity 18. Pump 20 may be an in-tank pump, and may be connected to top end 12 of tank 10 via a mounting flange 22. Pump 20 may be connected to top end 12 via another type of connection, if desired. Pump 20 may be configured to draw fuel from bottom end 14 of tank 10, pressurize the fuel, and deliver the fuel to a consumer, such as a gaseous fuel-powered engine.

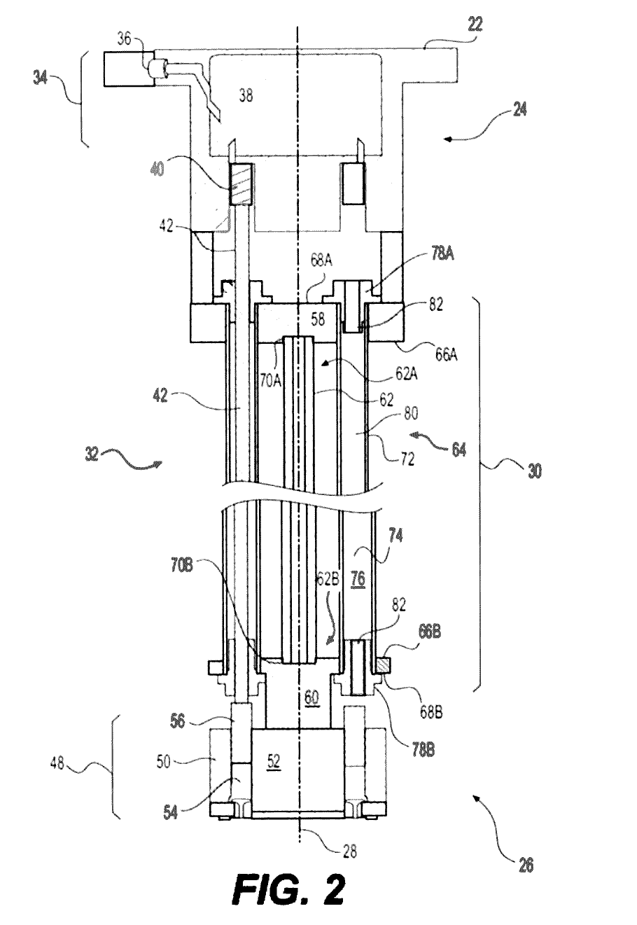

As shown in FIG. 2, pump 20 may include an actuating end 24 and a pressurizing end 26 opposite actuating end 24. Actuating and pressurizing ends 24, 26 may be aligned along a common axis 28 and connected via a support system 30. Axis 28 may also be the axial center of pump 20. A plurality of actuators 32 (only one shown in FIG. 2) may extend from actuating end 24 to pressurizing end 26 through support system 30. Actuators 32 may be configured to be reciprocally driven at actuating end 24 to generate a high-pressure fluid discharge at pressurizing end 26.

For example, actuating end 24 may include a driving mechanism 34 that is configured to sequentially drive actuators 32. Although driving mechanism 34 is embodied in FIG. 2 as a hydraulic system, driving mechanism 34 may alternatively embody another type of mechanism, such as a mechanically driven swash plate, a pneumatic system, a solenoid driven system, or other type of driving mechanism. Driving mechanism 34 may include a hydraulic inlet 36 that is configured to supply hydraulic fluid via an inlet manifold 38 to drive actuators 32.

Actuators 32 may include one or more components that cooperate to transmit mechanical energy from driving mechanism 34 to pressurizing end 26. For example, a plurality of tappets 40 may be axially driven by hydraulic fluid from inlet manifold 38. Each tappet 40 may be operatively connected to a connecting rod 42 that extends through support system 30 and operatively connects to one of a plurality of pumping elements 48. In some embodiments, connecting rod 42 may have a solid core. In other embodiments, connecting rod 42 may have a hollow core (i.e., may be tubular) to reduce the overall weight of pump 20. During downward strokes of tappet 40, connecting rod 42 may actuate one of a plurality of pumping elements 48 disposed in pressurizing end 26 to generate a pressurized fuel discharge. Actuators 32 may include more or fewer components, if desired.

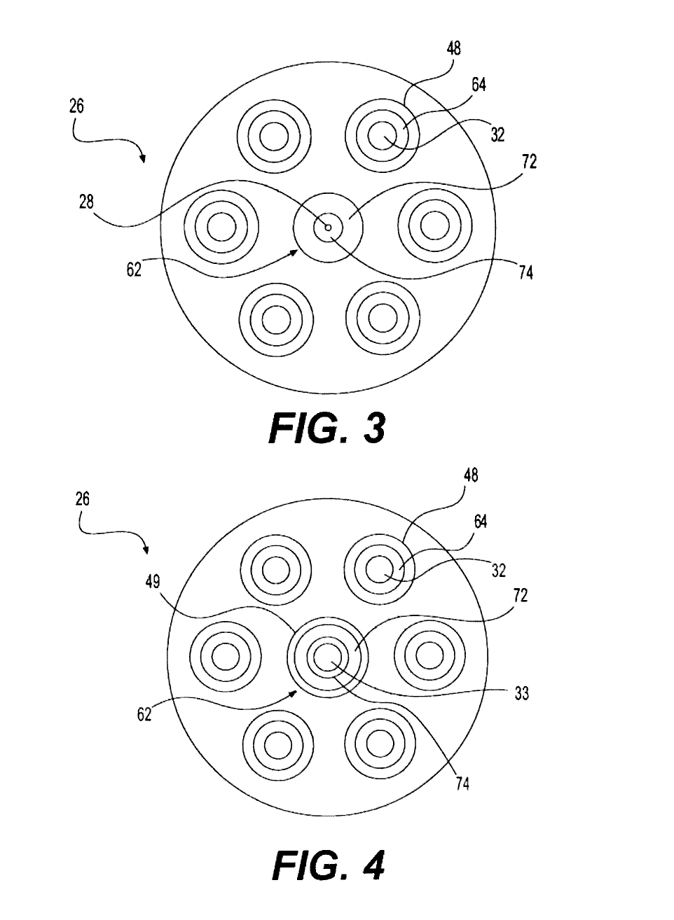

The plurality of pumping elements 48 disposed in pressurizing end 26 may be spaced radially outward from axis 28, as shown in FIG. 3. For example, pressurizing end 26 may include an even or odd number of pumping elements 48 spaced about axis 28. In some embodiments, each pumping element 48 may be equidistant from axis 28 and/or equidistant from each other. In some embodiments, pumping elements 48 may be evenly, symmetrically, or otherwise spaced about axis 28 in a generally circular, square, triangular, rectangular, or other pattern. In other embodiments, an additional pumping element 49 may be coaxially aligned with axis 28, as shown in FIG. 4. Other arrangements of pumping elements 48 may be used, if desired.

Returning to FIG. 2, each pumping element 48 may include a barrel 50 that is disposed in a barrel housing 52. Each barrel 50 may include a bore 54 disposed therein. Each bore 54 may be axially aligned with axis 28. A plunger 56 may be slidably disposed in each bore 54. Actuator 32 may reciprocally drive plunger 56 during pumping strokes to pressurize fuel within barrel 50.

Plunger 56 may slide between a Bottom-Dead-Center position (BDC) and a Top-Dead-Center (TDC) position within bore 54. When plunger 56 reaches BDC, fuel within cylinder may be highly pressurized and exert a correspondingly high reaction force against plunger 56 and the bottom of barrel 50. That is, as fuel becomes pressurized in bore 54 during downward strokes of plunger 56, the pressure in bore 54 may exert an upward force on plunger 56 that opposes the downward force applied to plunger 56 by actuator 32. Accordingly, the upward and downward forces may be coaxially aligned with the respective pumping element 48. The downward force may act against pressurizing end 26, while the upward force may act through actuator 32 and against actuating end 24, thereby tending to separate actuating end 24 from pressurizing end 26. The upward and downward forces may act at the same radially outward position as each respective pumping element 48.

Support system 30 may connect actuating end 24 to pressurizing end 26, and may be configured to oppose the separation of actuating and pressurizing ends 24, 26 during pumping strokes of pump 20. Support system 30 may include a first flange 58 connected to actuating end 24, a second flange 60 connected to pressurizing end 26, and a support member 62 between and abutting first and second flanges 58, 60. Support system 30 may also include a plurality of fasteners 64, each being connected to first and second flanges 58, 60. Each of the plurality of fasteners 64 may be configured to draw actuating and pressurizing ends 24, 26, (via first and second flanges 58, 60) against support member 62. Fasteners 64 may collectively function to clamp actuating and pressurizing ends 24, 26 against support member 62 to prevent their separation during pumping strokes.

First flange 58 may include an inner surface 66a that faces pressurizing end 26, and an outer surface 68a opposite inner surface 66a. Second flange 60 may include an inner surface 66b that faces actuating end 24, and an outer surface 68b opposite inner surface 66b. Flanges 58, 60 may be connected to actuating and pressurizing ends 24, 26, respectively, via bolts, screws, or another type of connection. In other embodiments, flanges 58, 60 may be integrally formed with actuating and pressurizing ends 24, 26, respectively. Flanges 58, 60 may be configured to allow actuators 32 to reciprocate through and/or between flanges 58, 60 to operatively connect actuating end 24 and pressurizing end 26.

Inner surface 66a may include a first socket 70a that is configured to receive a first end 62a of support member 62. Inner surface 66b may include a second socket 70b that is configured to receive a second end 62b of support member 62. When support system 30 is assembled, first end 62a of support member 62 may be positioned within first socket 70a, and second end 62b of support member 62 may be positioned within second socket 70b. First and second sockets 70a, 70a may prevent lateral movements of support member 62 at first and second ends 62a, 62b.

Support member 62 may be an elongate member that is configured to act as an abutment between actuating and pressurizing ends 24, 26. Support member 62 may be positioned between flanges 58, 60 along axis 26. To reduce the overall weight of pump 20, while providing rigid support between actuating and pressurizing ends 24, 26, support member 62 may be a slender rod or tubular member that is positioned centrally to pumping elements 48 and fasteners 64. Support member 62 may also be configured to withstand the clamping forces generated by fasteners 64 without buckling or failing. For example, on one hand, support member 62 may be made wider in order to withstand larger clamping forces. On the other hand, support member 62 may be made narrower to withstand smaller clamping forces, while reducing the overall weight and surface area of support member 62.

Support member 62 may embody a tubular member. That is, support member 62 may have a solid wall 72 and a hollow core 74 extending from first end 62a to second end 62b. A tubular cross section with a hollow portion may reduce the weight of support member 62, thereby reducing the overall weight of support system 30, while still providing rigid support between actuating and pressurizing ends 24, 26. By reducing the weight of support member 62, support system 30 may be made longer to reach the bottom of deeper and/or taller tanks without rendering pump 20 too heavy to be installed or supported within tank 10.

Having a tubular cross section may also allow support member 62 to conduct less heat between actuating and pressurizing ends 24, 26. Actuating end 24 may generally be warmer than pressurizing end 26, and heat conducted to pressurizing end 26 may cause fuel to vaporize and rise to top end 12 of tank 10 (referring to FIG. 1), which can reduce the amount of available fuel to be pumped from tank 10. The surface area of support member 62 at first and second ends 62a, 62b may be reduced by hollow core 74, thereby reducing the area over which heat can be conducted from actuating end 24 to pressurizing end 26. Additionally, when support system 30 is assembled, first and second ends 62a, 62b may be sealed against flanges 58, 60, creating a dead air space within hollow core 74. This dead air space may serve as insulation and further reduce heat transfer between actuating end 24 and pressurizing end 26.

As shown in the embodiment of FIG. 4, an additional actuator 33 may be slidably disposed within hollow core 74 of support member 62 and configured to drive additional actuator 49. In this way, the space central to fasteners 64 may be utilized by additional pumping element 49 to increase the pumping capacity of pump 20. As used herein, the term “slidably disposed” with regard to actuators 32 and additional actuator 33 is meant to include being movable relative to another element (e.g., fasteners 64 or support member 62) while having sliding contact with concentric positioning and/or non-contacting concentric positioning with the other element.

In other embodiments, support member 62 may have a solid cross section. For example, support member 62 may be a solid rod. A solid cross section may allow support member 62 to withstand greater forces than a tubular cross section for a given outer dimension (e.g., the same diameter, width, etc.). The outer dimension of support member may be constant from first end 62a to second end 62b, or it may vary. The cross section of support member 62 may be round (e.g., circular, elliptical, etc.) square, rectangular, triangular, or another shape.

As shown in FIGS. 3-4, fasteners 64 may each be coaxially aligned with a respective one of the plurality of pumping elements 48. Thus, when pumping elements 48 are spaced radially outward from axis 28, fasteners 64 may also be spaced radially outward from axis 28 and, therefore, spaced radially outward from support member 62. Coaxially aligning fasteners 64 with pumping elements 48 may allow fasteners 64 to be coaxially aligned with the forces acting to separate actuating end 24 and pressurizing end 26 during pumping strokes. Aligning fasteners 64 with these forces may reduce a lateral distance between them, thereby reducing an amount of torque and deflection that can be applied to fasteners 64 during pumping strokes.

Further, when pumping elements 48 are spaced symmetrically about axis 28, fasteners 64 may also be spaced symmetrically about axis 28, and therefore spaced symmetrically about support member 62. For example, pumping elements 48 of multi-cylinder axial pumps may be spaced symmetrically about axis 28 to achieve an even distribution of pumping force and torque about the center of pump 20. Spacing fasteners 64 symmetrically about support member 62 may allow for a correspondingly even distribution of clamping forces to be generated against support member 62 in opposition to the pumping forces and torque.

Returning to FIG. 2, fasteners 64 may be configured to draw first and second flanges 58, 60 against support member 62. For example, fasteners 64 may each include a bolt 76 that is configured to connect at first and second ends 62a, 62b to flanges 58, 60 via a first nut 78a and a second nut 78b, respectively. In one embodiment, first and second nuts 78a, 78b may be configured to be tightened against flanges 58, 60, for example, via a threaded connection with bolt 76. As nuts 78a, 78b are tightened against flanges 58, 60, forces of tension may be generated within bolt 76, thereby drawing flanges 58, 60 against support member 62.

To conserve space within support system 30, each of the plurality of actuators 32, which are also coaxially aligned with pumping elements 48, may be slidably disposed within a respective one of the plurality of fasteners 64. For example, bolt 76 may have a guide bore 80 that extends through a respective center of fastener 64. Each fastener 64 may be configured to allow actuator 32 to reciprocate within guide bore 80 of bolt 76. In this way, each actuator 32 may be protected from its surroundings, and each fastener 64 may be coaxially aligned with a respective one of the plurality of pumping elements 48. This axial alignment may allow each fastener 64 to directly oppose the forces acting to separate actuating and pressurizing ends 24, 26 and reduce the torque on bolt 76. By disposing actuators 32 within fasteners 64, more space around support member 62 may be available, which may allow for the inclusion of additional pumping element 49.

First and second nuts 78a, 78b may also be configured to allow actuators 32 to reciprocate through their respective centers. For example, first and second nuts 78a, 78b may each include a guide bore 82 that provides a path into guide bore 80 of bolt 76. First and second nuts 78a, 78b may each be in a sealed relationship with a respective one of the plurality of actuators 32. That is, at least one or more seals may be disposed within guide bore 82 to prevent fuel, lubricant, and debris from entering guide bore 80 of bolt 76. The use of seals may reduce cross contamination of fuel and lubricant, and may help maintain a dead air space within bolt 76 to reduce heat transfer between actuating and pressurizing ends 24, 26.

### INDUSTRIAL APPLICABILITY

The disclosed support system finds potential application in any fluid pump where a rigid support structure between actuating and pressurizing ends is desired, while reducing the cost and weight of the pump. The support system finds particular applicability in cryogenic pump applications, for example in-tank pumps used in conjunction with power systems having engines that burn LNG fuel. One skilled in the art will recognize, however, that the disclosed support system could be utilized in conjunction with other fluid systems that may or may not be associated with a power system. Operation of exemplary support system 30 will now be discussed.

Referring to FIG. 2, hydraulic fluid may be pumped into driving mechanism 34 of actuating end 24 via hydraulic inlet 36 of pump 20. The hydraulic fluid may be distributed via inlet manifold 38 to actuate a plurality of tappets 40. In embodiments where driving mechanism 34 is a mechanical device, such as a swashplate, a mechanical input (e.g., from a rotating shaft) may be received by actuating end 24 to actuate tappets 40. Driving mechanism 34 may actuate each tappet 40 sequentially. In other embodiments, however, driving mechanism 34 may be configured to actuate multiple tappets simultaneously or in an overlapping sequence.

During pumping strokes, each tappet 40 may transfer mechanical energy to connecting rod 42. Connecting rod 42 may receive mechanical energy from actuating end 24 and transfer the mechanical energy to pressurizing end 26. Connecting rod 42 may reciprocate within guide bore 80 of bolt 76 as well as guide bore 82 of first and second nuts 78a, 78bb. Seals may be disposed within guide bores 82 to help prevent fuel from entering guide bore 80 and traveling toward actuating end 24 as connecting rod 42 slides within guide bore 82. In this way, heat transfer from actuating end 24 to pressurizing end 26 may be reduced as the circulation of air, fuel vapor, etc., within guide bore 80 is reduced.

First and second nuts 78a, 78b may each be threaded to bolt 76. Screwing first and second nuts 78a, 78b to bolt 76 may draw first and second nuts 78a, 78b against flanges 58, 60, respectively. Further tightening first and second nuts 78a, 78b may draw flanges 58, 60 against support member 62, which abuts first and second flanges 58, 60. Tightening fasteners 64 may create a compressive force on support member 62. Flanges 58, 60 may be connected to actuating and pressurizing ends 24, 26, respectively, so that actuating and pressurizing ends 24, 26 are clamped together by the compressive force generated by fasteners 64. First and second sockets 70a, 70b may receive first and second ends 62a, 62b of support member 62 and prevent lateral movement of support member 62 when first and second nuts 78a, 78b are tightened.

In embodiments where support member 62 is a tubular member (e.g., instead of a rod), tightening first and second nuts 78a, 78b may seal first and second ends 62a, 62b against flanges 58, 60, thereby creating a dead air space within hollow core 74. The dead air space within hollow core 74 may reduce the surface area of wall 72 at first and second ends 62a, 62b, thereby reducing conductive heat transfer between actuating and pressurizing ends 24, 26. The dead air space within hollow core 74 may also insulate against convective heat transfer since air, fuel, etc., may not be able to circulate from first end 62a to second end 62b of support member.

As nuts 78a, 78b are tightened against flanges 58, 60, tensile forces may be generated within bolt 76. Support member 62 may resist the drawing together of actuating and pressurizing ends 24, 26, and a compressive force may be applied to support member 62. Further tightening of nuts 78a, 78b may increase the tensile forces known as “preload” within each fastener 64. These preload forces may provide the clamping force that holds actuating and pressurizing ends 24, 26 tightly against support member 62. The preload generated in fastener 64 may be proportional to the resulting clamping force applied to support member 62. Preload generated in each of the plurality of fasteners 64 may be added up as a total preload, and the total preload may be proportional to the total clamping force exerted on support member 62.

During pumping strokes, connecting rod 42 may transfer mechanical energy from driving mechanism 34 to plunger 56. Connecting rod 42 may drive plunger 56 downward into bore 54 to pressurize fuel therein. As the pressure within bore 54 increases, a reaction force may be generated that opposes the downward force applied by actuator 32. That is, as the pressure within bore 54 increases, the force of pressure may act downwardly on the bottom of barrel 50 within bore 54, and upwardly on plunger 56. The upward force acting on plunger 56 may be transferred to actuating end 24 via actuator 32, thereby applying an upward force on actuating end 24. The downward force acting on barrel 50 may apply a downward force on pressurizing end 26. Thus, the upward and downward forces may tend to force actuating end 24 and pressurizing end 26 apart.

As each fastener 64 is coaxially aligned with a respective one of the pumping elements 48, the upward and downward forces generated during pumping strokes may act to stretch each fastener 64. However, this stretching may occur only after the clamping force on support member 62 has been overcome. Thus, when the preload in fastener 64 is greater than the force generated by pumping element 48, fastener 64 may be prevented from stretching, and actuating and pressurizing ends 24, 26 may not separate. That is, the compressive force acting on support member 62 caused by tensile forces within fastener 64 may overcome the forces tending to separate actuating and pressurizing ends 24, 26.

Moreover, since the sum of the tensile forces generated by the plurality of fasteners 64 may be proportional to the total compressive force acting on support member 62, the total compressive force acting on support member 62 may be greater than the tensile force in any one of the plurality of fasteners 64. Similarly, the total compressive force acting on support member 62 may be greater than the force generated in any one of the plurality of pumping elements 48. Thus, during sequential actuation of pumping elements 48 (i.e., when pumping elements are actuated one at a time), the total compressive force acting on support member 62 to resist separation of actuating and pressurizing ends 24, 26 may be much greater than the forces generated by a single pumping element 48. In this way, a large clamping force can be generated by fasteners 64 in conjunction with a slender support member 62 to prevent the separation of actuating and pressurizing ends 24, 26.

Several advantages may be associated with the disclosed support system. For example, because each fastener 64 may be spaced laterally outward from support member 62, the tensile forces from each fastener 64 may collectively exert a cumulative compressive force on support member 62 to clamp actuating and pressurizing ends 24, 26 together. This radial configuration may also allow support member to be slender, thereby reducing the weight and thermal mass of support system 30. Additionally, because fasteners 64 may be coaxially aligned with actuators 32 and pumping elements 48, fasteners 64 may directly oppose the forces generated during pumping strokes, thereby reducing torque on fasteners 64.

It will be apparent to those skilled in the art that various modifications and variations can be made to the disclosed support system. Other embodiments will be apparent to those skilled in the art from consideration of the specification and practice of the disclosed support system. It is intended that the specification and examples be considered as exemplary only, with a true scope being indicated by the following claims and their equivalents.

What is claimed is:

1. A support system for a pump having a plurality of pumping elements, the support system comprising:
a first flange;
a second flange opposite the first flange;
a support member between and abutting the first and second flanges; and
a plurality of fasteners, each being coaxially aligned with a respective one of the plurality of pumping elements, wherein each of the plurality of fasteners is configured to draw the first and second flanges against the support member.

2. The support system of claim 1, wherein each of the plurality of fasteners is spaced radially outward from the support member.

3. The support system of claim 1, wherein each of the plurality of fasteners includes a guide bore extending through a respective center of each fastener.

4. The support system of claim 3, wherein each of the plurality of fasteners is connected in tension to the first flange via a first nut, and to the second flange via a second nut.

5. The support system of claim 4, wherein the first and second nuts each include a guide bore passing through a respective center of each of the first and second nuts.

6. The support system of claim 5, wherein the pump includes a plurality of actuators configured to reciprocate between the first and second flanges, and the first and second nuts are each configured to be in a sealed relationship with one of the plurality of actuators.

7. The support system of claim 1, wherein the support member is a solid rod.

8. The support system of claim 1, wherein the support member is a tubular member having a solid wall and a hollow core.

9. The support system of claim 8, wherein the support member is coaxially aligned with one of the plurality of pumping elements.

10. The support system of claim 1, wherein the first flange includes a first socket configured to receive a first end of the support member, and the second flange includes a second socket configured to receive a second end of the support member.

11. A pump, comprising:
an actuating end having a driving mechanism;
a pressurizing end opposite the actuating end and including a plurality of pumping elements;
a plurality of actuators, each configured to be reciprocally driven between the driving mechanism and a respective one of the plurality of pumping elements;
a support member between and abutting the actuating and pressurizing ends; and
a plurality of fasteners, each being configured to draw the actuating and pressurizing ends against the support member, wherein each of the plurality of actuators is slidably disposed within a respective one of the plurality of fasteners.

12. The pump of claim 11, wherein each of the plurality of fasteners includes a guide bore extending through a respective center of each fastener.

13. The pump of claim 12, wherein each of the plurality of fasteners is connected in tension to the actuating end via a first nut, and to the pressurizing end via a second nut.

14. The pump of claim 13, wherein each of the first and second nuts includes a guide bore passing through a respective center of each of the first and second nuts.

15. The pump of claim 14, wherein the guide bore of each of the first and second nuts is in a sealed relationship with one of the plurality of actuators.

16. The pump of claim 11, wherein each of the plurality of pumping elements is spaced radially outward from the support member.

17. The pump of claim 11, wherein the support member is one of a solid rod and a tubular member, wherein the tubular member has a solid wall and a hollow core.

18. The pump of claim 17, wherein the support member is a tubular member, and the pump further includes:
an additional pumping element coaxially aligned with the support member; and
an additional actuator slidably disposed within the support member.

19. The pump of claim 11, wherein the actuating end includes a first socket configured to receive a first end of the support member, and the pressurizing end includes a second socket configured to receive a second end of the support member.

20. A pump, comprising:
an actuating end having a driving mechanism;
a pressurizing end opposite the actuating end and including a plurality of pumping elements, each being spaced radially outward from and symmetrically arranged about an axial center of the pump;
a plurality of actuators, each configured to be reciprocally driven between the driving mechanism and a respective one of the plurality of pumping elements;
a first flange connected to the actuating end;
a second flange connected to the pressurizing end;
a support member between and abutting the first and second flanges; and
a plurality of fasteners, wherein:
each of the plurality of fasteners is connected to the first and second flanges and configured to draw the actuating and pressurizing ends against the support member;
each of the plurality of fasteners includes a guide bore passing through a respective center of each fastener; and
each of the plurality of actuators is slidably disposed within the guide bore of a respective one of the plurality of fasteners.
